(19) United States
(12) Patent Application Publication
(10) Pub. No.: US 2026/0009878 A1
(43) Pub. Date: Jan. 8, 2026

(54) DIRECTIONALITY CALIBRATION IN WIRELESS COMMUNICATION

(71) Applicant: Cohere Technologies, Inc., San Jose, CA (US)

(72) Inventor: Clayton AMBROSE, San Jose, CA (US)

(21) Appl. No.: 18/993,454

(22) PCT Filed: Jul. 10, 2023
(86) PCT No.: PCT/US2023/069894

§ 371 Date: Jan. 10, 2025

Related U.S. Application Data
(60) Provisional application No. 63/368,598, filed on Jul. 15, 2022.

(51) Int. Cl. G01S 5/02; H04B 7/06

(52) U.S. Cl. CPC G01S 5/021; G01S 5/0215; H04B 7/0617

(57) ABSTRACT

A method of wireless communication includes performing a first measurement of a wavefront received at a first antenna of a base station configured to provide a wireless communication access to user devices in a coverage area, performing a second measurement of the wavefront received at a second antenna of the base station, wherein the first antenna and the second antenna are separated by a separation distance along a direction, deriving a compensation factor from the first measurement and the second measurement, wherein the compensation factor is used for estimating an estimated angle of arrival (AOA) and performing the subsequent communication by applying the compensation factor to an outgoing or an incoming signal waveform to or from a user device.

### CROSS-REFERENCE TO RELATED APPLICATION

This application claims priority to U.S. Provisional Application No. 63/368,598, filed on Jul. 15, 2022, the disclosure of which is hereby incorporated by reference herein in its entirety.

### TECHNICAL FIELD

The present document relates to wireless communication.

### BACKGROUND

Due to an explosive growth in the number of wireless user devices and the amount of wireless data that these devices can generate or consume, current wireless communication networks are fast running out of bandwidth to accommodate such a high growth in data traffic and provide high quality of service to users.

Various efforts are underway in the telecommunication industry to come up with next generation of wireless technologies that can keep up with the demand on performance of wireless devices and networks. Many of those activities involve situations in which a large number of user devices may be served by a network.

### SUMMARY

This document discloses techniques that may be used by wireless networks to achieve several operational improvements.

In one example aspect, a wireless communication method is disclosed. The method includes performing a first measurement of a wavefront received at a first antenna of a base station configured to provide a wireless communication access to user devices in a coverage area; performing a second measurement of the wavefront received at a second antenna of the base station, wherein the first antenna and the second antenna are separated by a separation distance along a direction; deriving a compensation factor from the first measurement and the second measurement, wherein the compensation factor is used for estimating an estimated angle of arrival (AOA); and performing the subsequent communication by applying the compensation factor to an outgoing or an incoming signal waveform to or from a user device.

In another example aspect, another wireless communication method is disclosed. The method includes determining, by a base station configured to provide wireless communication access using a first communication protocol, an uplink alignment for a user device based on a first signal received in an uplink direction, wherein the uplink alignment includes one or more of aligning a phase, a gain, a timing or a polarization difference between different receiving antennas of the base station based on an estimated angle of arrival (AoA) for the user device, determining an estimate of an estimated downlink alignment of the user device by transmitting a plurality of shaped interference signal transmissions to the user device in a transmission pattern, wherein each of the shaped interference signal is shaped according to a current estimate of the downlink alignment of a user device, wherein the current estimate of the downlink alignment is based on the uplink alignment or previously received feedback signals that were received in response to previously transmissions of shaped interference signal transmissions; and performing subsequence downlink transmissions using the estimated downlink alignment.

In another example aspect, a wireless communication apparatus that implements the above-described methods is disclosed.

In yet another example aspect, a wireless system in which one or more of the above-described methods are implemented is disclosed.

In yet another example aspect, the method may be embodied as processor-executable code and may be stored on a computer-readable program medium.

In yet another aspect, a wireless communication system that operates by providing a single pilot tone for channel estimation is disclosed.

These, and other, features are described in this document.

### DESCRIPTION OF THE DRAWINGS

Drawings described herein are used to provide a further understanding and constitute a part of this application. Example embodiments and illustrations thereof are used to explain the technology rather than limiting its scope.

FIG. 1 shows an example communication network.

FIG. 2 shows a simplified example of a wireless communication system in which uplink and downlink transmissions are performed.

FIG. 3 depicts an example of an embodiment of angle of arrival (AoA) measurement.

FIG. 4 shows an example of a transmit/receive chain of a multi-antenna port wireless communication apparatus.

FIG. 5A-5C show beamforming achieved by various embodiments.

FIG. 6 shows an example of an AoA calibration embodiment compatible with a Long Term Evolution (LTE) communication protocol.

FIG. 7 shows an example of an AoA calibration embodiment compatible with New Radio (NR) communication protocol.

FIG. 8 shows an example of an uplink calibration process.

FIG. 9 and FIG. 10 show examples of simulations results regarding calibration measurement accuracy.

FIG. 11 is a flowchart of a calibration process example.

FIG. 12 shows an example of a hardware platform.

FIG. 13 is a flowchart for an example method of wireless communication.

FIG. 14 is a flowchart for an example method of wireless communication.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only. Furthermore, certain standard-specific terms are used for illustrative purpose only, and the disclosed techniques are applicable to any wireless communication systems.

### 1. Introduction-Wireless Communication Environment

The wireless or time-variant nature of the communication channel poses several challenges in design a transmission protocol suitable for wireless communication scenarios. These days, users expect their wireless devices to work everywhere and in a variety of mobile or stationary situations.

The time-variant nature of a wireless network and the expectation by users of a reliable, high-bandwidth network connection at any time and in any place creates a tension between amount of transmission resources a wireless network may use for overhead signal communications for calibration of a wireless channel while at the same allocating as much transmission bandwidth to user data as possible. Deployments of user devices and network devices having multiple antennas makes this problem becomes even more challenging because wireless networks may need to calibrate wireless channel to/from each antenna of a multi-antenna device.

The techniques described in the present application allow for calibration of uplink or downlink wireless network connections using various techniques that provide operational advantages as further described throughout the present document.

### 2. Example Wireless Systems

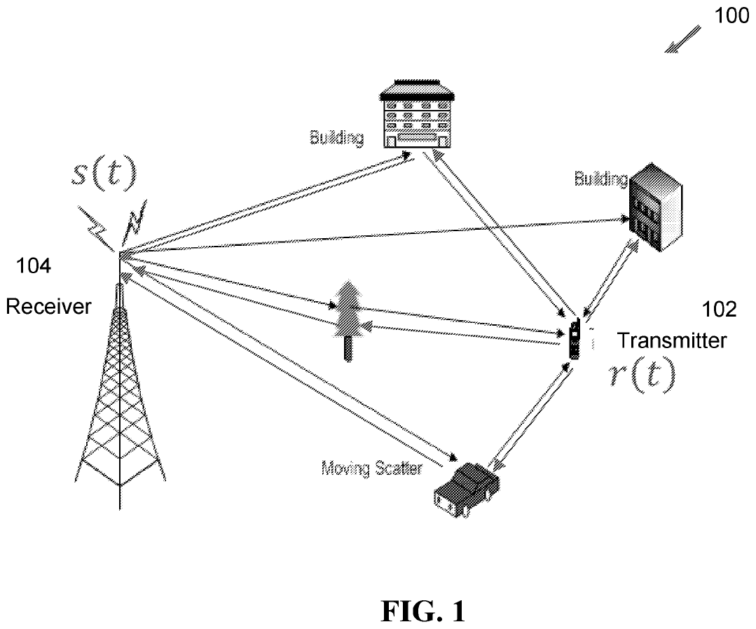

FIG. 1 shows an example of a wireless communication system 100 in which a transmitter device 102 transmits signals to a receiver 104. The signals may undergo various wireless channels and multipaths, as depicted. Some reflectors such as buildings and trees may be static, while others such as cars, may be moving scatterers. The transmitter device 102 may be, for example, a user device, a mobile phone, a tablet, a computer, or another Internet of Things (IoT) device such as a smartwatch, a camera, and so on. The receiver device 104 may be a network device such as the base station. The signals transmitted from the base station to the transmitter 102 may experience similar channel degradations produced by static or moving scatterers. The techniques described in the present document may be implemented by the devices in the wireless communication system 100. The terms “transmitter” and “receiver” are simply used for convenience of explanation and, as further described herein, depending on the direction of transmission (uplink or downlink), the network station may be transmitting or receiving and user device may be receiving or transmitting.

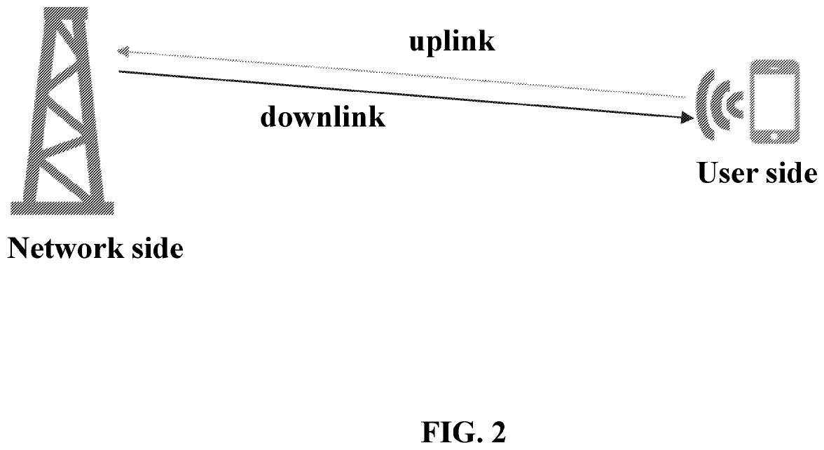

FIG. 2 shows a simplified wireless network to highlight certain aspects of the disclosed technology. A transmitter transmits wireless signals to a receiver in the wireless network. Some transmissions in the network, variously called as downlink or downstream transmissions, a network-side node such as a base station acts as a transmitter of wireless signals and one or more user devices act as the receiver of these wireless signals. For some other transmissions, as depicted in FIG. 2, the direction of transmission may be opposite. Such transmissions are often called uplink or upstream transmissions. For such transmissions, one or more user devices act as transmitters of the wireless signals and a network-side node such as the base station acts as the receiver of these signals (as depicted in FIG. 2). Other type of transmissions in the network may include device-to-device transmissions, sometimes called direct or sideband transmissions. While the present document primarily uses the terms “downlink” and “uplink” for the sake of convenience, similar techniques may also be used for other situations in which transmissions in two directions are performed—e.g., inbound or incoming transmissions that are received by a wireless device and outbound or outgoing transmissions that are transmitted by a wireless device. For example, downlink transmissions may be inbound transmissions for a user device, while outbound transmissions for a network device. Similarly, uplink transmission may be inbound transmissions for a network device while outbound transmissions from a wireless device. Therefore, for some embodiments, the disclosed techniques may also be described using terms such as “inbound” and “outbound” transmission without importing any 3GPP-specific or other wireless protocol-specific meaning to the terms “uplink” and “downlink.”

In frequency division multiplexing (FDM) networks, the transmissions to a base station and the transmissions from the base station may occupy different frequency bands (each of which may occupy continuous or discontinuous spectrum). In time division multiplexing (TDM) networks, the transmissions to a base station and the transmissions from the base station occupy a same frequency band but are separated in time domain using a TDM mechanism such as time slot-based transmissions. Other types of multiplexing are also possible (e.g., code division multiplexing, orthogonal time frequency space, or OTFS, multiplexing, spatial multiplexing, etc.). In general, the various multiplexing schemes can be combined with each other. For example, in spatially multiplexed systems, transmissions to and from two different user devices may be isolated from each other using directional or orientational difference between the two end points (e.g., the user devices and a network station such as a base station).

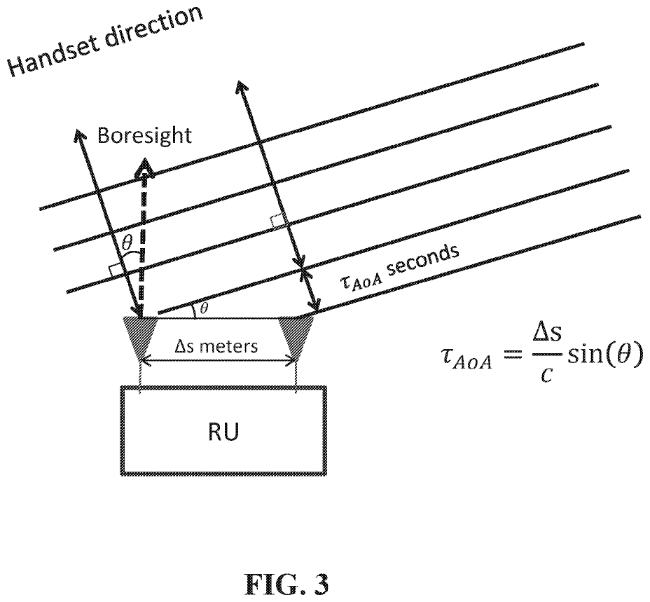

FIG. 3 depicts an example of an embodiment of angle of arrival (AoA) measurement. Here, RU represents a Radio Unit corresponding to a transmit/receive circuitry of a wireless communication apparatus. RU is equipped with multiple antenna ports, which are shown as two separate antennas for simplicity. The antennas may be associated with a physical separation of As meters, called separation distance. A direction perpendicular to the separation distance direction may represent the boresight of the antenna array. FIG. 1 shows that a particular handset or a user device may be in a direction different from the boresight direction. The angle between the boresight direction and the handset direction may be represented as θ (theta). Due to this angle, an impinging wavefront from the handset may reach two different antenna ports at two different times T_{AOA} which may be represented by the equation:

$${τ}_{AoA} = \frac{Δ s}{c} sin ( θ ) \qquad Eq ( 1 )$$

Where c represents speed of light. In some embodiments, the RU may make measurements, as further disclosed in the present document, to measure the AoA of each user device, which in turn may be used in beamforming for communication with the particular user device. By performing beamforming, transmission energy may be focused in a specific direction to maximize signal transmission in that direction, thereby achieving communication with best quality (e.g., highest signal to noise ratio) without creating interference to other user device.

Beamforming, however, relies on feeding signals into an antenna array with the proper complex weights. When a system is uncalibrated, due to imperfections in the RF paths such as mismatched cables, connectors, trace lengths, impedance, antenna gains, etc. the intended complex weights are changed. This corrupts the beam pattern. Likewise, it corrupts angle-of-arrival measurements in the uplink.

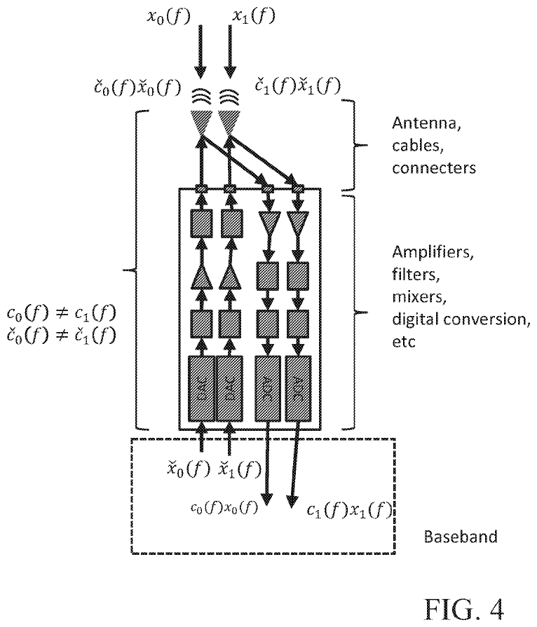

FIG. 4 shows an example of impact of uncalibrated TX or RX signal paths on beamforming. FIG. 4 depicts a transmit/receive chain of a multi-antenna port wireless communication apparatus. For simplicity, a case of two antenna ports separated by certain linear distance is shown. The antenna ports receive two slightly different versions of a same wavefront, represented as x₀(f) and x₁(f). The uncalibrated signal is modelled in the frequency domain as

$$y ( f ) = c ( f ) \cdot x ( f ) = \sqrt{g ( f )} {e}^{j ( ϕ - 2 πτ f )} \cdot x ( f ) . \qquad Eq ( 2 )$$

c(f) is the calibration impairment, and τ, ϕ, g are respectively delay, phase and gain offsets.

Given multiple antennas in a uniform linear array, with a UE at some θ angle of arrival (AoA), we have the following uncalibrated signal model

$${y}_{k} ( f ) = {c}_{k} ( f ) \cdot {a}_{k} ( θ , f ) \cdot {x}_{k} ( f ) = \sqrt{g ( f )} {e}^{j ( ϕ - 2 {πτ}_{k} f )} \cdot {e}^{- j 2 π k {τ}_{AoA} f} \cdot x ( f ) . \qquad Eq ( 3 )$$

As depicted in FIG. 4, the received signal may go through a receive chain comprising antennas, cables, connecters, followed by amplifiers, filters, mixers, analog-to-digital conversion, etc. On the transmit side, typical signal processing is in a reverse direction-with digital-to-analog conversion, followed by amplifier, upconversion, cables, antenna elements, etc. Due to implementation tolerances, each transmit or receive chain may introduce a delay specific to that chain.

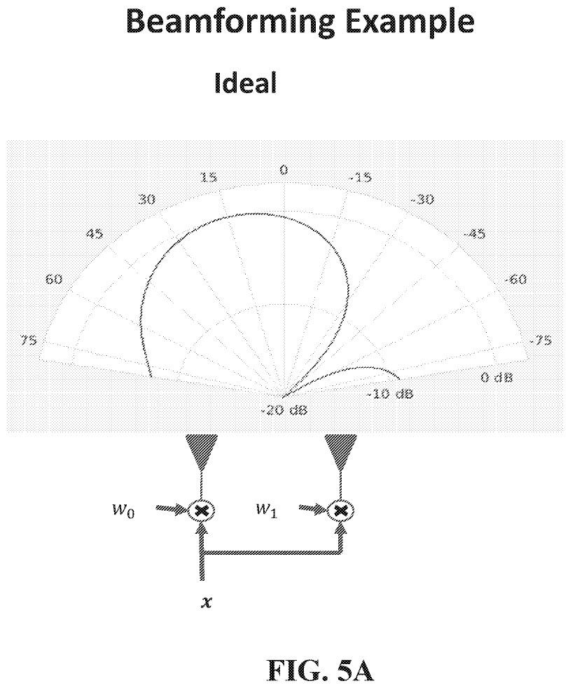

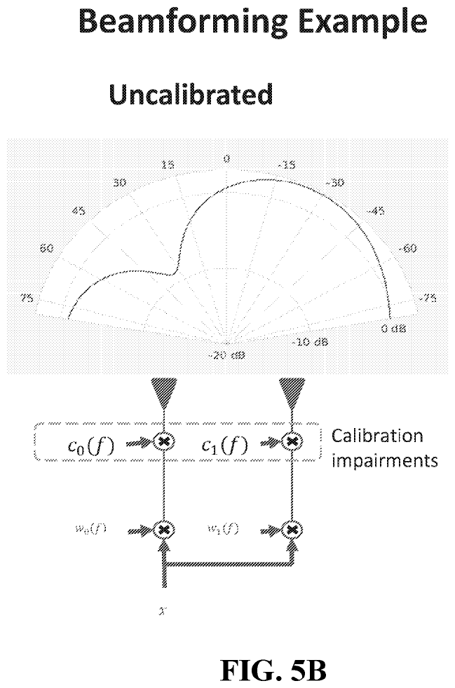

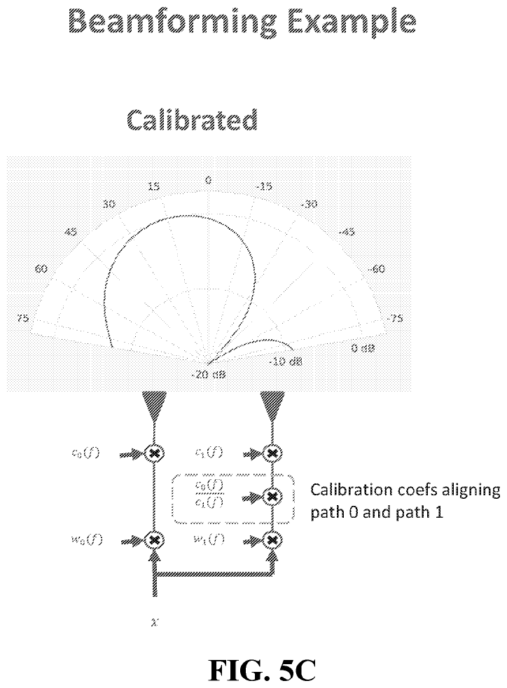

FIG. 5A-5C show beamforming achieved by various embodiments. FIG. 5A shows a case in which “ideal” beamforming may occur where the weights w0 and w1 are selected to form a beam in a desired direction. As depicted, a main lobe of energy may point in the desired direction (e.g., 15 degrees), with side lobes suppressed 20 dB or better. Here, it is assumed that the AoA for the target user device has been estimated as disclosed in the present document.

FIG. 5B shows another example where calibration impairments produce uneven distortion in each transmit or receive chain, and the resulting uncalibrated beam may be formed in a direction that is different from the desired direction as shown in FIG. 5A.

FIG. 5C shows an embodiment in which AoA distortions are calibrate and corresponding compensatory gains are applied in order to produce a beam pattern that is close to the ideal beam pattern as shown in FIG. 5A. In the depicted embodiment, a calibration coefficient alignment is performed by applying an inverse ratio factor of the ratio between two different processing chains of two antenna ports. Alternatively, coefficient alignment may be applied to each signal processing path to match each path's signal distortions to a uniform level.

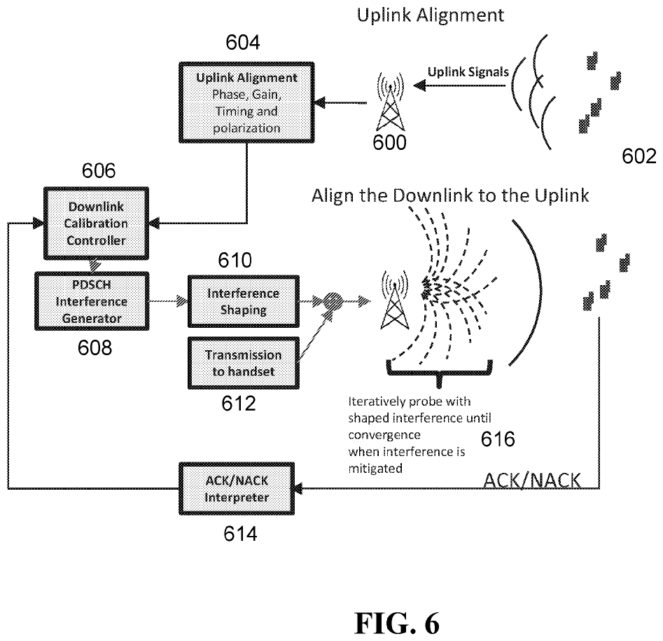

FIG. 6 shows an example of an AoA calibration embodiment compatible with a Long Term Evolution (LTE) communication protocol. A number of user devices 602 may be in the coverage area of a wireless network that implements the LTE or LTE-A protocol. A base station 600 may receive uplink signals from the user devices and perform uplink alignment as described in the present document (604). The uplink alignment may be performed on phase, gain timing and polarization used by the transmission signals. The results of the uplink alignment may be provided to a downlink calibration controller 606. The downlink calibration controller 606 may control a PDSCH (physical downlink shared channel) interference generator 608 that controls the functions of interference shaping (610) and a transmission subsystem (612) that generates signals for downlink transmissions to user devices 602. Specifically, the downlink transmissions may comply with the LTE/LTE-A protocol but may include a shaped interference signal that is intentionally included in the downlink transmission to assist with downlink channel calibration as described herein.

The downlink calibration controller 606 may receive feedback from the user devices 602 in the form of, for example, ACK/NACK messages, and other channel calibration feedback according to the LTE/LTE-A protocol. The feedback messages may be used by the downlink calibration controller 606 to control a transmission pattern of the shaped interference signal, as described herein. An ACK/NACK interpreter 614 may receive these messages and decode and interpret for the downlink calibration controller 606. As further described throughout the present document, 616 depicts iterative or repeated transmission of shaped interference signals to achieve a convergence in measurements for a certain UE.

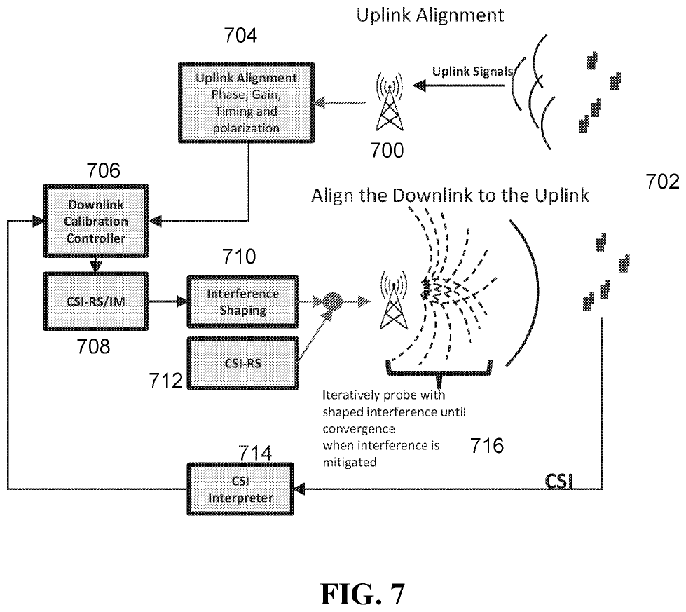

FIG. 7 shows an example of an AoA calibration embodiment compatible with New Radio (NR) communication protocol, also called fifth generation or 5G protocol. A number of user devices 702 may be in the coverage area of a wireless network that implements the 5G protocol. A base station 700 may receive uplink signals from the user devices and perform uplink alignment as described in the present document (704). The uplink alignment may be performed on phase, gain timing and polarization used by the transmission signals. The results of the uplink alignment may be provided to a downlink calibration controller 706. The downlink calibration controller 706 may control a channel state information (CSI) interference measurement generator 708 that controls the functions of interference shaping (710) and a transmission subsystem (712) that generates CSI reference signals for downlink transmissions to user devices 702. Specifically, the downlink transmissions may comply with the 5G protocol but may include a shaped interference signal that is intentionally included in the downlink transmission to assist with downlink channel calibration as described herein.

The downlink calibration controller 706 may receive feedback from the user devices 702 in the form of, for example, channel quality information (CQI) messages such as CSI reports, and other channel calibration feedback according to the 5G protocol. The feedback messages may be used by the downlink calibration controller 706 to control a transmission pattern of the shaped interference signal, as described herein. The feedback messages may be parsed and interpreted by a CSI interpreter 714. As further described throughout the present document, 716 depicts iterative or repeated transmission of shaped interference signals to achieve a convergence in measurements for a certain UE.

### 3. Examples of Uplink Calibration

With respect to the uplink calibration, in some embodiments, gain, phase and timing alignment is performed independently per polarization. Gain is determined by measuring the difference in average receive power per port. Phase and timing is determined in the phase domain and is subject to ambiguity or aliasing due to the combination of AoAs along with the phase and timing. By removing AoA terms based on relative UE locations the phase and timing offsets can be isolated and measured.

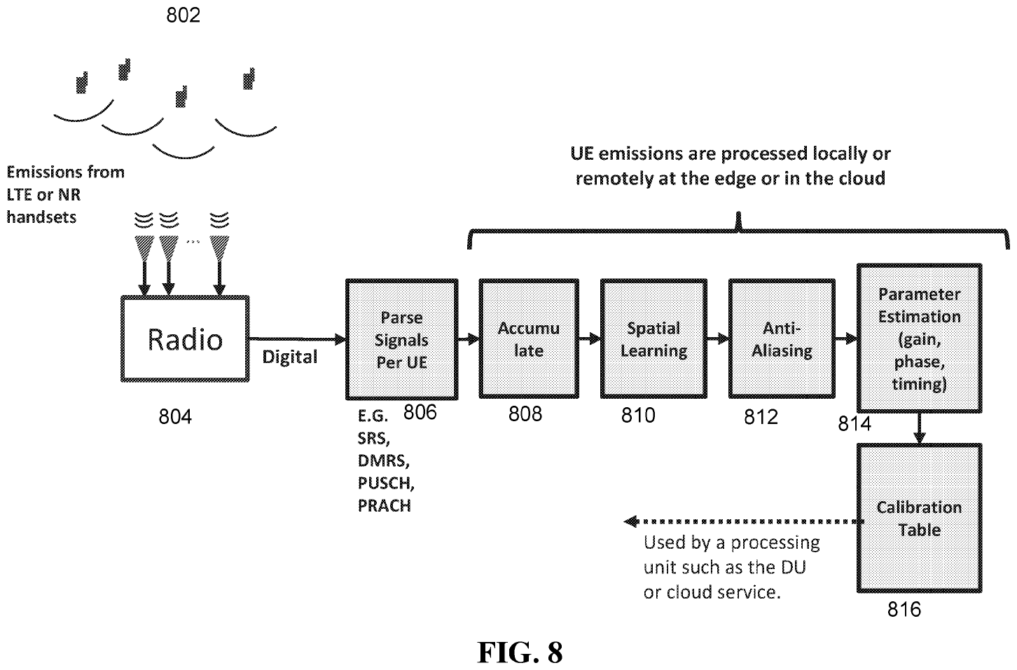

FIG. 8 shows an example of an uplink calibration process. User devices 802 may be in communication with a network-side radio station 804. The protocol used for this communication may be a legacy protocol such as LTE, 5G or another protocol. The radio station 804 may process signals received at the multiple antennas from each of the multiple user devices 802. From the received signal waveforms, the radio station 804 may extract the various signals received according to the communication protocols. These transmission signals may include, for example, sounding reference signal SRS transmissions, demodulation reference signal DMRS transmissions, PUSCH (physical uplink shared channel). PRACH (physical random access) transmissions, and so on. For each user device, the radio station 804 may accumulate (808) one or more transmissions of each type of signal from the user device received over multiple instances. The accumulated signals may be used to perform spatial learning (810). An anti-aliasing operation (812) may be performed on the results of spatial learning to ensure removal of alias images. The resulting spatial information of the user devices may be used to estimate gain, phase and delay parameters (814). These results may be stored to a calibration table 816 and made available for use by a scheduler that schedules transmission resources to/from each user device and network. The scheduler may be implement at a distributed unit (DU) or in a cloud-based service. The operations performed in 808 to 814 may also be similarly either performed locally at the radio station 804 or using cloud-based computing resources or a combination thereof.

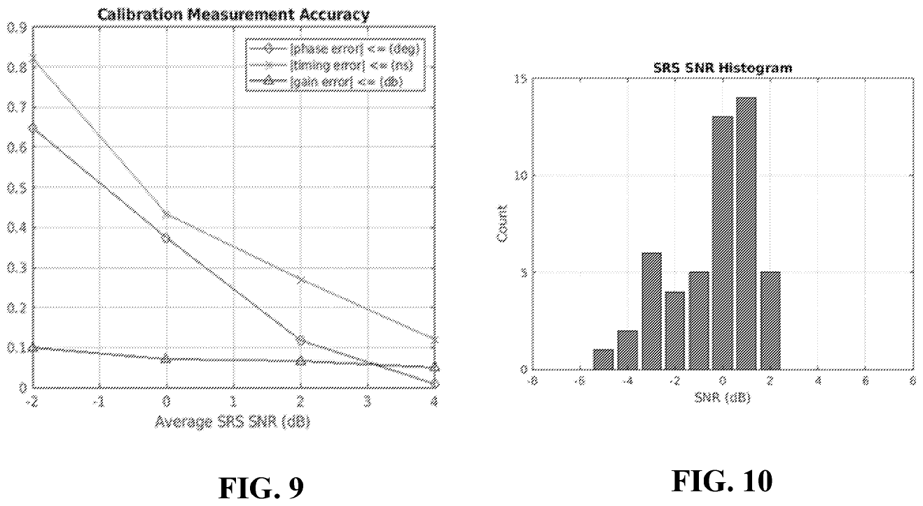

FIG. 9 and FIG. 10 show examples of simulations results regarding calibration measurement accuracy. In the depicted example, a 4G LTE sector configuration was used in which 1.95 GHz carrier frequency was used and a bandwidth of 10 MHz was used for the frequency ban. The system used 4 transmit and 4 receive antennas. The initial calibration offset that was applied to the antenna ports in listed in Table 1. Results obtained by processing of 100 sounding-reference-signals (SRS) spanning 48 PRBs (physical resource blocks), over variable SNR (signal to noise ratio) distribution averaging from −2 to 4 dB (example SNR distribution shown in the histogram below), achieved calibration with accuracy shown in the graph depicted in FIG. 9.

Referring to FIG. 9, horizontal axis shows an average signal to noise ratio (SNR) of SRS while vertical axis shows typical phase, timing and gain errors. FIG. 10 shows a corresponding histogram, with horizontal axis showing SNR and vertical axis showing count in the simulation.

TABLE 1

| | Gain | Phase | Timing |
|---|---|---|---|
| Port # | (dBm) | (deg) | (nsec) |
| 1 | −0.2 | 87.0 | −1.53 |
| 2 | −0.6 | −41.0 | −0.08 |
| 3 | −1.9 | 141.6 | 0.36 |
| 4 | −1.4 | 31.4 | 1.24 |

Table 2 below shows that the estimates converge to a low value after 100 iterations.

TABLE 2

| | |
|---|---|
| Abs(Gain Error) < (dB) | 0.1 |
| Abs(Phase Error) < (deg) | 0.4 |
| Abs(Timing Error) < (nsec) | 0.44 |

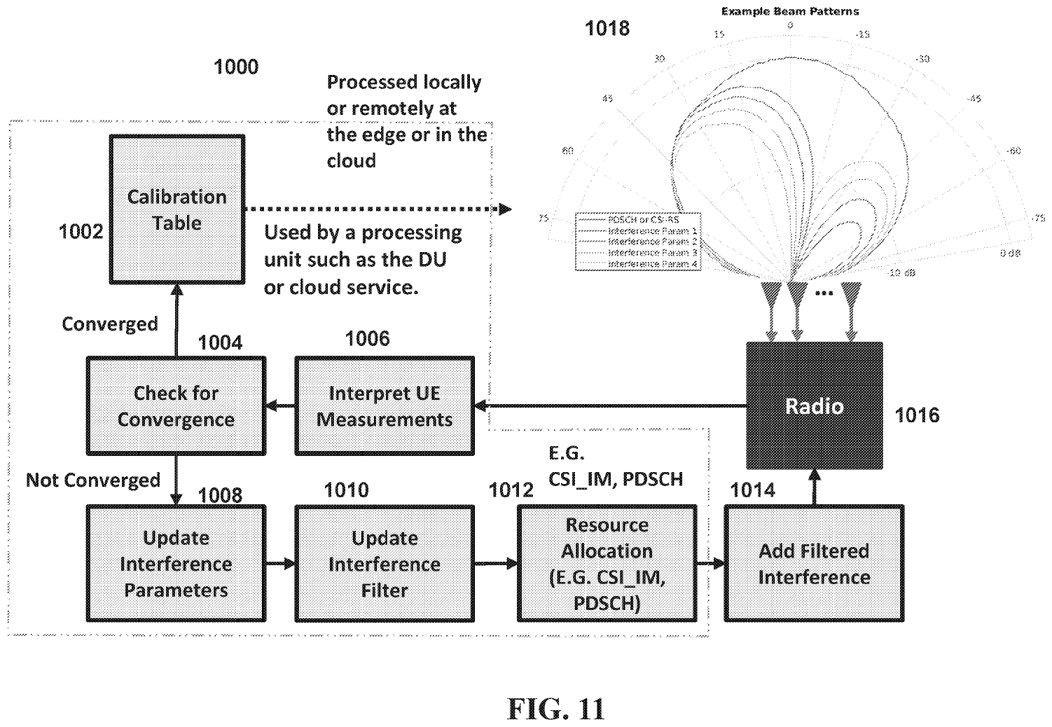

FIG. 11 is an example implementation of a calibration process 1000 which may be implemented at a network device or using a cloud-based distributed computing resource. The various logical operational groupings include a calibration table maintained based on previously performed calibrations (e.g., as described with reference to FIG. 8). The table is generated and updated upon the system reaching a convergence as determined by a convergence checking operation 1004. When the convergence checking operation 1004 determines that convergence has not been reached, interference parameters of the shaped interference may be updated (1008) and optionally an interference filter may be updated (1010). Based on these updates, further resources may be allocated (1012) for downstream transmission of shaped interference, which is then added (1014) to other ongoing transmissions in the network and transmitted out from the radio station 1016 to user devices in the network (not explicitly shown). On the uplink side, transmissions received from the user devices may be interpreted (1006) for checking for convergence. Convergence may be indicated when different settings of shaped interference transmissions do not result in appreciable changes to feedback received from a particular under device (e.g., difference in reported channel quality is below a threshold).

### 4. Examples of Downlink Calibration

Gain, phase and timing alignment is performed independently per polarization. A search over parameters is performed based on spatially directed contamination in the form of interference or reference signals. Afterward the polarizations are spatially aligned based on similarity of phase differences.

### 5. Examples of Alignment Between Uplink and Downlink

Gain, phase and timing alignment is performed independently per polarization. Relative to uplink spatial channel info, a search over parameters is performed based on spatially directed contamination in the form of interference or reference signals. Afterward the polarizations are spatially aligned based on similarity of phase differences.

### 6. Examples of Embodiments

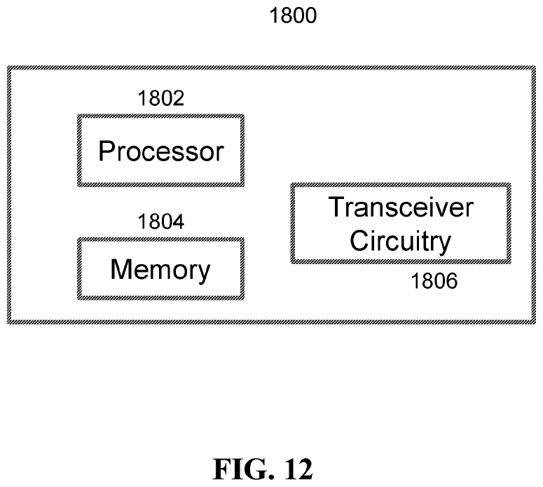

FIG. 12 is a block diagram representation of a wireless hardware platform 1800 which may be used to implement the various methods described in the present document. The hardware platform 1800 may be incorporated within a base station or a user device. The hardware platform 1800 includes a processor 1802, a memory 1804 and a transceiver circuitry 1006. The processor may execute instructions, e.g., by reading from the memory 1804, and control the operation of the transceiver circuitry 1806 and the hardware platform 1800 to perform the methods described herein. In some embodiments, the memory 1804 and/or the transceiver circuitry 1806 may be partially or completely contained within the processor 1802 (e.g., same semiconductor package).

The following examples highlight some embodiments that use one or more of the techniques described herein.

For example, angle or arrival or channel in an uplink direction may be measured using the following solutions.

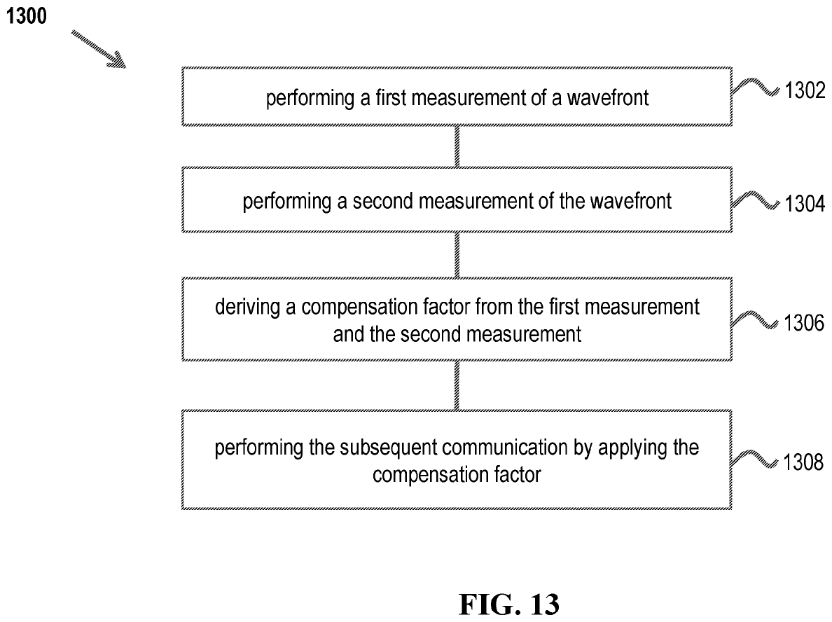

1. A method of wireless communication (e.g., method 1300 depicted in FIG. 13), comprising: performing (1302) a first measurement of a wavefront received at a first antenna of a base station configured to provide a wireless communication access to user devices in a coverage area; performing (1304) a second measurement of the wavefront received at a second antenna of the base station, wherein the first antenna and the second antenna are separated by a separation distance along a direction; deriving (1306) a compensation factor from the first measurement and the second measurement, wherein the compensation factor is used for estimating an estimated angle of arrival (AOA); and performing (1308) the subsequent communication by applying the compensation factor to an outgoing or an incoming signal waveform to or from a user device.

2. The method of solution 1, wherein the compensation factor is applied to a component of the incoming signal waveform received via the first antenna or the second antenna, or the compensation factor is applied to a component of an outgoing signal waveform transmitted via the first antenna or the second antenna.

3. The method of solution 1, wherein the compensation factor is applied by: applying a first compensation factor to a first component of the incoming signal waveform received via the first antenna and a second compensation factor to a second component of the incoming signal waveform received via the second antenna, applying a first compensation factor to a first component of the outgoing signal waveform transmitted via the first antenna and a second compensation factor to a second component of the outgoing signal waveform transmitted via the second antenna.

4. The method of any of solutions 1-3, wherein an amplitude or a phase of the compensation factor is a function of frequency. Some examples are disclosed with reference to Section 2, e.g., equations 2 and 3.

5. The method of solution 4, wherein the compensation factor is stored in a calibration table and periodically estimated. Advantageously, the calibration table may be used by other layers of protocol stack implementation.

6. The method of any of solutions 1-5, wherein cloud computing resources are used to estimate the AOA or to determine the compensation factor for the user devices.

For example, channel in a downlink direction may be calibrated using the following preferred embodiments.

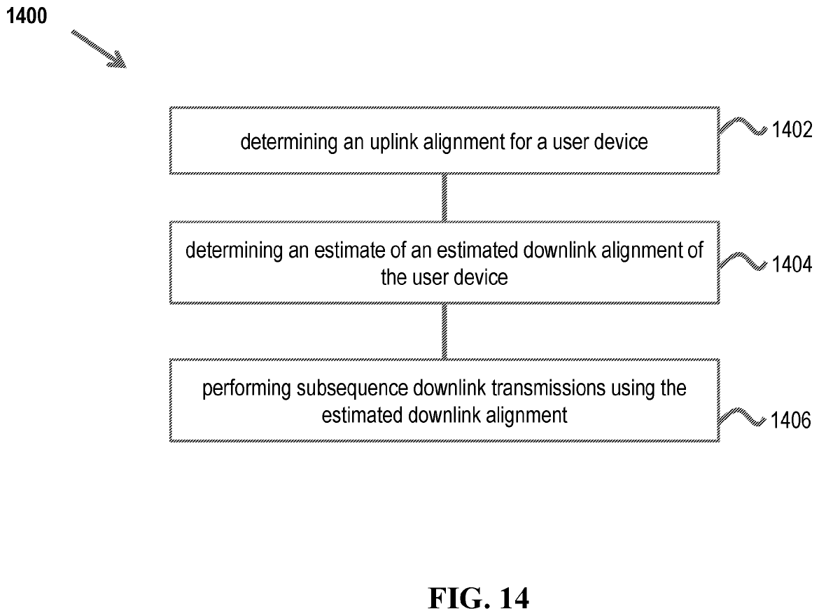

7. A method of wireless communication (e.g., method 1400 depicted in FIG. 14), comprising: determining (1402), by a base station configured to provide wireless communication access using a first communication protocol, an uplink alignment for a user device based on a first signal received in an uplink direction, wherein the uplink alignment includes one or more of aligning a phase, a gain, a timing or a polarization difference between different receiving antennas of the base station based on an estimated angle of arrival (AoA) for the user device, determining (1404) an estimate of an estimated downlink alignment of the user device by transmitting a plurality of shaped interference signal transmissions to the user device in a transmission pattern, wherein each of the shaped interference signal is shaped according to a current estimate of the downlink alignment of a user device, wherein the current estimate of the downlink alignment is based on the uplink alignment or previously received feedback signals that were received in response to previously transmissions of shaped interference signal transmissions; and performing (1406) subsequence downlink transmissions using the estimated downlink alignment.

8. The method of solution 7, wherein each of the plurality of shaped interference transmissions is a spatially selective beam defined by an angular bandwidth and wherein the transmission pattern comprises sweeping different ones of the plurality of shaped interference transmissions across an angular range.

9. The method of any of solutions 7-8, wherein the shaped interference signal is a noise signal.

10. The method of any of solutions 7-8, wherein the shaped interference signal uses transmission resources of a pre-defined reference signal of a legacy protocol.

11. The method of solution 10, wherein the legacy protocol comprises Long Term Evolution (LTE) protocol and wherein the pre-defined reference signal occupies a physical downlink shared channel.

12. The method of solution 10, wherein the legacy protocol comprises 5th Generation New Radio (NR) protocol and wherein the pre-defined reference signal comprises a channel state information reference signal.

13. The method of any of solutions 7-12, wherein the previously received feedback signals comprise a reference signal measurement report.

14. The method of any of solutions 7-12, wherein the previously received feedback signals comprise an ACK/NACK indicator.

15. The method of any of solutions 7-12, wherein the previously received feedback signals comprise a channel state report.

16. The method of any of solutions 7-15, wherein the plurality of shaped interference transmissions includes interference transmissions performed at different times.

17. The method of any of solutions 7-16, wherein the plurality of shaped interference transmissions includes interference transmissions performed at different angles.

18. The method of any of solutions 7-17, wherein the plurality of shaped interference transmissions includes interference transmissions performed using different ranks or antenna ports.

19. The method of any of solutions 1-12, wherein the transmission pattern defines a temporal sequence of transmissions.

20. The method of any of solutions 7-19, wherein the transmission pattern defines a spatial sequence of transmissions.

21. The method of any of solutions 7-20, wherein the transmission pattern defines map of resource elements used for transmissions.

22. The method of any of solutions 7-21, wherein the shaped interference signal comprises a data or control signal transmission to one or more other user devices.

23. A wireless communication apparatus comprising a processor and a transceiver, wherein the processor is configured to perform a method recited in any one or more of above solutions.

24. A system comprising a plurality of wireless communication apparatus, each apparatus comprising one or more processors, configured to implement a method recited in any one or more of above solutions.

25. A technique, method or apparatus disclosed in the present document.

In the above-described embodiments and solutions, in some embodiments, the first measurement and the second measurement include the calculations disclosed in Sections 1 to 5 of the present document. In some embodiments, the measurement may use a locally running time clock to capture the time instances at which the wavefront is received at the first or second antenna. In some embodiments, the measurements may be performed contemporaneously, such that both the first and second measurements are performed before initiating a next sequence of measurements using a next received wavefront.

In the above-described embodiments and solutions, in some embodiments, the compensation factor may be a real, integer or a fraction or non-imaginary number. In some embodiments, the compensation factor may be a complex number, e.g., having a real and an imaginary part representing a phase shift. In some embodiments, the compensation factor may be a single value. In some embodiments, the compensation factor may be a multi dimensional value (e.g., a pre-coding or a post-coding matrix).

In the above-described embodiments and solutions, the shaped interference may be used to ascertain impact of occupancy of certain transmission resources by a signal on the quality of signal reception by each UE. For example, in some embodiments, the shaped interference may be swept through a transmission pattern in which the shaped interference is beamformed along different spatial directions. . . e.g., direction 1, direction 2, . . . direction N. Here, N may be a positive integer between 2 to 360 (e.g., one direction per one radian). In some cases, the full sweep of directionality may be split into a manageable number of sectors, e.g., 20 sectors that overlap with each other 50%, giving 36 directional transmissions. Based on uplink feedback from a particular user device, the direction that causes the worst degradation to the channel measured by the particular user device may be noted.

Alternatively, or in addition, the shaped interference may be swept across different time-frequency locations in the transmission scheme. For example, the interference signal may follow a particular sweeping pattern (e.g., a random hop) among the resource elements being received by a UE during channel measurement and feedback collected for each transmission may be used to perform uplink calibration.

Alternatively, or in addition, the shaped interference may be transmitted along a temporal sequence transmission pattern. For example, a baseline sweep rate of the shaped interference signal to cover an entire cell may be pre-defined. Depending on number of user devices in the cell, the temporal sequence may be increased (more frequent transmissions of shaped interference) or decreased. Similarly, a cell may further be divided into angular or radial sectors and different temporal transmission patterns may be used for the divisions based on a desired accuracy/resolution which may be a function of the number of UEs in that division or properties of a wireless channel due to presence of reflectors in the division. In some implementations, the number of shaped interference sweeps for a particular UE may depend on an estimate of how fast the channel to/from the UE is changing. For example, shaped interference transmissions to a stationary or a low-speed UE may be performed at a slower rate than shaped interference transmission to moving UE.

It will be appreciated that the present document provides various techniques that may be used by embodiments to perform uplink calibration in which signal paths of different antenna ports may be aligned in gain, phase, timing and polarization. The wireless communication apparatus may be an integrated radio unit or may comprise separate antennas. In various embodiments, the calibration may be performed using data signals or using reference signals. The techniques may be applied both in a wideband situation where a signal used for the calibration occupies entire channel bandwidth or in a narrowband situation where the signal used for calibration occupies a smaller bandwidth than the channel. The calibration computations may be performed by a processor at the radio unit or may be performed using cloud-based computing resources. It will also be appreciated that the disclosed techniques may be applied to different duplexing schemes, e.g., TDD (time division duplexing) or FDD (frequency division duplexing). Furthermore, the techniques may be used in any frequency band, e.g., a sub 6 GHz frequency band or a millimeter wave (mm-wave) band. It will also be appreciated that the disclosed techniques do not impose a specific requirement on the number of transmit or receive antennas and may in general be applicable to an NtNr situation, where Nt represents number of transmit antennas and Nr represents number of receive antennas.

It will further be appreciated that the present document discloses techniques allowing calibration of signal paths in the downlink direction, to align gain, phase, timing or polarization. In some embodiments, an existing reference signal may be used for performing the alignment. For example, the previously disclosed CSI reference signal may be used. In some embodiments, a shaped interference signal may be used in the downlink direction. In the feedback direction, an existing reporting mechanism such as Channel Quality Indicator CQI, Precoding Matrix Indicator PMI or ACK/NACK may be used. It will also be appreciated that the disclosed techniques may be applied to different duplexing schemes, e.g., TDD or FDD. Furthermore, the techniques may be used in any frequency band, e.g., a sub 6 GHz frequency band or a millimeter wave (mm-wave) band. It will also be appreciated that the disclosed techniques do not impose a specific requirement on the number of transmit or receive antennas and may in general be applicable to an NtNr situation, where Nt represents number of transmit antennas and Nr represents number of receive antennas.

It will further be appreciated that the present document discloses techniques that may be used by embodiments to spatially align downlink transmissions and uplink transmissions between a network device and a user device, along with alignment of corresponding polarization. The alignment may be achieved by calibrating uplink and downlink based on reference signal transmissions or data transmissions. Such techniques may use existing mechanisms such as existing reference signals and existing feedback signals, as discussed throughout the present document. It will also be appreciated that the disclosed techniques may be applied to different duplexing schemes, e.g., TDD or FDD. Furthermore, the techniques may be used in any frequency band, e.g., a sub 6 GHz frequency band or a millimeter wave (mm-wave) band. It will also be appreciated that the disclosed techniques do not impose a specific requirement on the number of transmit or receive antennas and may in general be applicable to an NtNr situation, where Nt represents number of transmit antennas and Nr represents number of receive antennas.

It will further be appreciated that the above-described calibration method may be performed using a custom hardware such as a user device that is under full control of a network device or is a test device deployed by a network operator. Alternatively, the calibration may be performed based on user devices that are placed at a known location during a calibration phase.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
performing a first measurement of a wavefront received at a first antenna of a base station configured to provide a wireless communication access to user devices in a coverage area;
performing a second measurement of the wavefront received at a second antenna of the base station, wherein the first antenna and the second antenna are separated by a separation distance along a direction;
deriving a compensation factor from the first measurement and the second measurement, wherein the compensation factor is used for estimating an estimated angle of arrival (AOA); and
performing subsequent communication by applying the compensation factor to an outgoing or an incoming signal waveform to or from a user device.

2. The method of claim 1, wherein the compensation factor is applied to a component of the incoming signal waveform received via the first antenna or the second antenna, or the compensation factor is applied to a component of an outgoing signal waveform transmitted via the first antenna or the second antenna.

3. The method of claim 1, wherein the compensation factor is applied by:
applying a first compensation factor to a first component of the incoming signal waveform received via the first antenna and a second compensation factor to a second component of the incoming signal waveform received via the second antenna, or
applying a first compensation factor to a first component of the outgoing signal waveform transmitted via the first antenna and a second compensation factor to a second component of the outgoing signal waveform transmitted via the second antenna.

4. The method of claim 1, wherein an amplitude or a phase of the compensation factor is a function of frequency.

5. The method of claim 4, wherein the compensation factor is stored in a calibration table and periodically estimated.

6. The method of claim 1, wherein cloud computing resources are used to estimate the AOA or to determine the compensation factor for the user devices.

7-25. (canceled)

26. The method of claim 2, wherein an amplitude or a phase of the compensation factor is a function of frequency.

27. The method of claim 26, wherein the compensation factor is stored in a calibration table and periodically estimated.

28. The method of claim 3, wherein an amplitude or a phase of the compensation factor is a function of frequency.

29. The method of claim 28, wherein the compensation factor is stored in a calibration table and periodically estimated.

30. An apparatus for wireless communication comprising one or more processors configured to cause the apparatus to implement a method comprising:
performing a first measurement of a wavefront received at a first antenna of the apparatus configured to provide a wireless communication access to user devices in a coverage area;
performing a second measurement of the wavefront received at a second antenna of the apparatus, wherein the first antenna and the second antenna are separated by a separation distance along a direction;
deriving a compensation factor from the first measurement and the second measurement, wherein the compensation factor is used for estimating an estimated angle of arrival (AOA); and
performing subsequent communication by applying the compensation factor to an outgoing or an incoming signal waveform to or from a user device.

31. The apparatus of claim 30, wherein the compensation factor is applied to a component of the incoming signal waveform received via the first antenna or the second antenna, or wherein the compensation factor is applied to a component of an outgoing signal waveform transmitted via the first antenna or the second antenna.

32. The apparatus of claim 30, wherein the compensation factor is applied by:
applying a first compensation factor to a first component of the incoming signal waveform received via the first antenna and a second compensation factor to a second component of the incoming signal waveform received via the second antenna, or
applying a first compensation factor to a first component of the outgoing signal waveform transmitted via the first antenna and a second compensation factor to a second component of the outgoing signal waveform transmitted via the second antenna.

33. The apparatus of claim 30, wherein an amplitude or a phase of the compensation factor is a function of frequency.

34. The apparatus of claim 33, wherein the compensation factor is stored in a calibration table and periodically estimated.

35. The apparatus of claim 31, wherein an amplitude or a phase of the compensation factor is a function of frequency.

36. The apparatus of claim 35, wherein the compensation factor is stored in a calibration table and periodically estimated.

37. The apparatus of claim 32, wherein an amplitude or a phase of the compensation factor is a function of frequency.

38. The apparatus of claim 37, wherein the compensation factor is stored in a calibration table and periodically estimated.
